(19) United States
(12) Patent Application Publication
(10) Pub. No.: US 2003/0074530 A1
(43) Pub. Date: Apr. 17, 2003

(54) LOAD/STORE UNIT WITH FAST MEMORY DATA ACCESS MECHANISM

(76) Inventors: RUPAKA MAHALINGAIAH, AUSTIN, TX (US); AMIT GUPTA, AUSTIN, TX (US)

Correspondence Address: DAN. R. CHRISTEN, CONLEY, ROSE & TAYON, P.C., P.O. BOX 398, AUSTIN, TX, 78767-0398, US

(21) Appl. No.: 08/989,210

(22) Filed: Dec. 11, 1997

(51) Int. Cl. G06F 12/00

(52) U.S. Cl. 711/117; 711/126; 711/146; 711/215; 712/233

(57) ABSTRACT

A load/store unit comprising a load/store buffer and a memory access buffer. The load store buffer is coupled to a data cache and is configured to store information on memory operations. The memory access buffer is configured to store addresses and data associated with the requested addresses for at least one of the most recent memory operations. The memory access buffer, upon detecting a load memory operation, outputs data associated with the load memory operation's requested address. If the requested address is not stored within the memory access buffer, the memory access buffer is configured to store the load memory operation's requested address and associated data when it becomes available from the data cache. Similarly, store memory operation requested address and associated data is also stored.

### BACKGROUND OF THE INVENTION

1. Field of the Invention

This invention relates to microprocessors and, more particularly, to load/store units within microprocessors.

2. Description of the Related Art

Superscalar microprocessors achieve high performance by simultaneously executing multiple instructions in a clock cycle and by specifying the shortest possible clock cycle consistent with the design. As used herein, the term “clock cycle” refers to an interval of time during which the pipeline stages of a microprocessor perform their intended functions. At the end of a clock cycle, the resulting values are moved to the next pipeline stage.

Since superscalar microprocessors execute multiple instructions per clock cycle and the clock cycle is short, a high bandwidth memory system is required to provide instructions and data to the superscalar microprocessor (i.e. a memory system that can provide a large number of bytes in a short period of time). Without a high bandwidth memory system, the microprocessor would spend a large number of clock cycles waiting for instructions to be provided, then would execute the received instructions in a relatively small number of clock cycles. Overall performance would be degraded by the large number of idle clock cycles. However, superscalar microprocessors are ordinarily configured into computer systems with a large main memory composed of dynamic random access memory (DRAM) cells. DRAM cells are characterized by access times which are significantly longer than the clock cycle of modern superscalar microprocessors. Also, DRAM cells typically provide a relatively narrow output bus to convey the stored bytes to the superscalar microprocessor. Therefore, DRAM cells provide a memory system that provides a relatively small number of bytes in a relatively long period of time, and do not form a high bandwidth memory system.

Because superscalar microprocessors are typically not configured into a computer system with a memory system having sufficient bandwidth to continuously provide instructions and data for execution, superscalar microprocessors are often configured with caches. Caches are small, fast memories that are either included on the same monolithic chip with the microprocessor core, or are coupled nearby. Data and instructions that have been used recently by the microprocessor are typically stored in these caches, and are discarded or written back to memory (if modified) after the instructions and data have not been accessed by the microprocessor for some time. The amount of time necessary before instructions and data are vacated from the cache and the particular algorithm used therein varies significantly among microprocessor designs, and are well known. Data and instructions may be stored in a shared cache, variously referred to as a combined cache or a unified cache. Also, data and instructions may be stored in distinctly separated caches, typically referred to as instruction caches and data caches.

Retrieving data from main memory is typically performed in superscalar microprocessors through the use of a load instruction. This instruction may be explicit, wherein the load instruction is actually coded into the software being executed. This instruction may also be implicit, wherein some other instruction (e.g., an add) directly requests the contents of a memory location as part of its input operands.

Storing the results of instructions back to main memory is typically performed in superscalar microprocessors through the use of a store instruction. As with the aforementioned load instruction, the store instruction may be explicit or implicit. As used herein, “memory operations” will be used to refer to load and/or store instructions.

In modern superscalar microprocessors, memory operations are typically executed in one or more load/store units. These units execute the instruction, access the data cache (if one exists) attempting to find the requested data, and handle the result of the access. A data cache access typically has one of two results: a hit or a miss. A hit occurs when data associated with the requested address is found in the data cache. A miss occurs when data associated with the requested address is not found in the data cache.

To increase the percentage of hits, many superscalar microprocessors use caches organized into a “set-associative” structure. In a set-associative structure, the blocks of storage locations are accessed as a two-dimensional array having rows and columns. For example, when a load/store unit searches a data cache for data residing at an address, a number of bits from the address are used as an “index” into the cache. The index selects a particular row within the two-dimensional array. Therefore, the number of address bits required for the index is determined by the number of rows configured into the data cache. The addresses associated with data bytes stored in the multiple blocks of a row are examined to determine if any of the addresses stored in the row match the requested address. As described above, if a match is found, the access is said to be a “hit”, and the data cache provides the associated data bytes. If a match is not found, the access is said to be a “miss.” When a miss is detected, the load/store unit causes the instruction bytes to be transferred from the memory system into the data cache. The addresses associated with data bytes stored in the cache are also stored. These stored addresses are referred to as “tags.”

The blocks of memory configured into a row form the columns of the row. Each block of memory is referred to as a “way”; multiple ways comprise a row. The way is selected by providing a way value to the instruction cache. The way value is determined by examining the tags for a row and finding a match between one of the tags and the input address from the fetch control unit.

It is well known that set-associative caches provide better “hit rates” (i.e. a higher percentage of accesses to the cache are hits) than caches that are configured as a linear array of storage locations (typically referred to as a direct-mapped configuration). The hit rates are better for set-associative caches because bytes stored at multiple addresses having the same index may be stored in a set-associative cache simultaneously, whereas a direct-mapped cache is capable of storing only one set of bytes per index. For example, if a program has a loop that reads data from two addresses having the same index, a set-associative cache could store data bytes from both addresses. A direct mapped cache, however, will have to repeatedly reload the two addresses each time the loop is executed.

The hit rate in a data cache is important to the performance of the superscalar microprocessor because when a miss is detected the data must be fetched from the memory system. The microprocessor will quickly become idle while waiting for the data to be provided. Unfortunately, set-associative caches require more access time than direct-mapped caches. The tags must be compared to the address being searched for, and the resulting hit or miss information must then be used to select which instruction bytes should be conveyed out of the instruction cache to the instruction processing pipelines of the superscalar microprocessor. With the clock cycles of superscalar microprocessors being shortened, this cache access time becomes a problem. Often four or more clock cycles may be required to provide data from a data cache. Therefore, a mechanism for providing faster data access from a cache is desirable.

### SUMMARY OF THE INVENTION

The problems outlined above are in large part solved by a load/store unit in accordance with the present invention. In one embodiment, the load/store unit comprises a load/store buffer and a memory access buffer. The load/store buffer is coupled to a data cache and is configured to store information on memory operations comprising requested address, tag, and status information. The memory access buffer is coupled to the load/store buffer and is configured to store requested addresses and associated data for at least one recent memory operation. The memory access buffer is also configured, upon detecting a load memory operation, to output data associated with the load memory operation's requested address to a result bus if the requested address is stored within the memory access buffer. If the requested address is not stored within the memory access buffer, the memory access buffer is configured to store the load memory operation's requested address and associated data when it becomes available from the data cache. Advantageously, the requested data may be provided to reservation stations in a shorter period of time.

The memory access buffer may be configured, upon detecting a store memory operation, to store the store memory operation's requested address and associated data. This feature advantageously aids in maintaining data coherency between the memory access buffer and the data cache without requiring large amounts of die space or complicated circuitry.

In another embodiment, the load/store unit is configured to output data associated with a load memory operation's requested address to the result bus before the data cache is able to do so.

In another embodiment, the load/store unit comprises a load/store buffer, a multiplexer, and a memory access buffer. The load/store buffer is configured to store information for a plurality of memory operations, wherein the information comprises requested address, tag, and status information. The multiplexer is coupled to the load/store buffer and is configured to select at least one requested address from the load/store buffer for access to a data cache. The memory access buffer is coupled to the multiplexer and is configured to store requested address and data information for at least one recent memory operation. The memory access buffer is also configured to receive said at least one requested address from the multiplexer and output any stored data associated with said at least one requested address.

Also contemplated is a method for providing fast access to memory data. The method comprises storing requested addresses and associated data from store memory operations in a memory access buffer. When a load memory operation is detected, the requested address is compared with the addresses stored in the memory access buffer. If there is a match, data associated with the requested address is output onto a result bus. If the requested address is not stored in the memory access buffer, the requested address and data are stored in the memory access buffer when they become available from the data cache.

### BRIEF DESCRIPTION OF THE DRAWINGS

Other objects and advantages of the invention will become apparent upon reading the following detailed description and upon reference to the accompanying drawings in which:

FIG. 1 is a block diagram of a superscalar microprocessor.

FIG. 2 is a block diagram of one embodiment of the load/store unit and data cache shown in FIG. 1.

FIG. 3 is a diagram showing one embodiment of the memory access buffer depicted in FIG. 2.

FIG. 4 is a diagram showing one embodiment of the load/store buffer in FIG. 2.

FIG. 5A is a timing diagram depicting the relationship between a load/store unit and a data cache.

FIG. 5B is another timing diagram depicting the relationship between a load/store unit and a data cache.

FIG. 6A is a timing diagram depicting the relationship between the load/store unit and data cache depicted in FIG. 2 when a buffer hit occurs.

FIG. 6B is another timing diagram depicting the relationship between the load/store unit and data cache depicted in FIG. 2 when a buffer hit occurs.

FIG. 7A is a timing diagram depicting the relationship between the load/store unit and data cache depicted in FIG. 2 when a buffer miss occurs.

FIG. 7B is another timing diagram depicting the relationship between the load/store unit and data cache depicted in FIG. 2 when a buffer miss occurs.

FIG. 8 is a diagram showing one embodiment of a computer system configured to utilize the microprocessor of FIG. 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

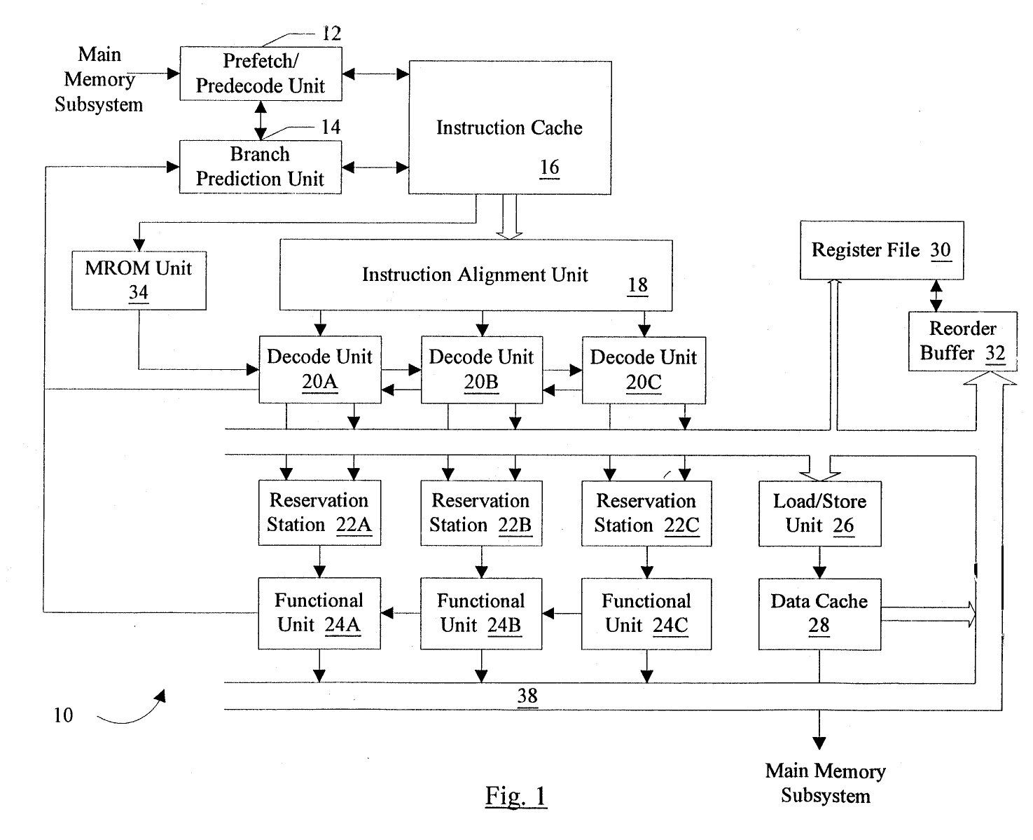

Turning now to FIG. 1, a block diagram of one embodiment of a microprocessor 10 is shown. Microprocessor 10 includes a prefetch/predecode unit 12, a branch prediction unit 14, an instruction cache 16, an instruction alignment unit 18, a plurality of decode units 20A-20C, a plurality of reservation stations 22A-22C, a plurality of functional units 24A-24C, a load/store unit 26, a data cache 28, a register file 30, a reorder buffer 32, and an MROM unit 34. Elements referred to herein with a particular reference number followed by a letter will be collectively referred to by the reference number alone. For example, decode units 20A-20C will be collectively referred to as decode units 20.

Prefetch/predecode unit 12 is coupled to receive instructions from a main memory subsystem (not shown), and is further coupled to instruction cache 16 and branch prediction unit 14. Similarly, branch prediction unit 14 is coupled to instruction cache 16. Still further, branch prediction unit 14 is coupled to decode units 20 and functional units 24. Instruction cache 16 is further coupled to MROM unit 34 and instruction alignment unit 18. Instruction alignment unit 18 is in turn coupled to decode units 20. Each decode unit 20A-20C is coupled to load/store unit 26 and to respective reservation stations 22A-22C. Reservation stations 22A-22C are further coupled to respective functional units 24A-24C. Additionally, decode units 20 and reservation stations 22 are coupled to register file 30 and reorder buffer 32. Functional units 24 are coupled to load/store unit 26, register file 30, and reorder buffer 32 as well. Data cache 28 is coupled to load/store unit 26 and to the main memory subsystem. Finally, MROM unit 34 is coupled to decode units 20.

Generally speaking, instruction cache 16 is a high speed cache memory provided to store instructions. Instructions are fetched from instruction cache 16 and dispatched to decode units 20. In one embodiment, instruction cache 16 is configured to store up to 32 kilobytes of instructions in a 4-way set associative structure having 32 byte lines (a byte comprises 8 binary bits). Instruction cache 16 may additionally employ a way prediction scheme in order to speed access times to the instruction cache. Instead of accessing tags identifying each line of instructions and comparing the tags to the fetch address to select a way, instruction cache 16 predicts the way that is accessed. In this manner, the way is selected prior to accessing the instruction storage. The access time of instruction cache 16 may be similar to a direct-mapped cache. A tag comparison is performed and, if the way prediction is incorrect, the correct instructions are fetched and the incorrect instructions are discarded. It is noted that instruction cache 16 may be implemented as a fully associative, set associative, or direct mapped configuration.

Instructions are fetched from main memory and stored into instruction cache 16 by prefetch/predecode unit 12. Instructions may be prefetched prior to the request thereof from instruction cache 16 in accordance with a prefetch scheme. A variety of prefetch schemes may be employed by prefetch/predecode unit 12. As prefetch/predecode unit 12 transfers instructions from main memory to instruction cache 16, prefetch/predecode unit 12 generates three predecode bits for each byte of the instructions: a start bit, an end bit, and a functional bit. The predecode bits form tags indicative of the boundaries of each instruction. The predecode tags may also convey additional information such as whether a given instruction can be decoded directly by decode units 20 or whether the instruction is executed by invoking a microcode procedure controlled by MROM unit 34, as will be described in greater detail below. Still further, prefetch/predecode unit 12 may be configured to detect branch instructions and to store branch prediction information corresponding to the branch instructions into branch prediction unit 14.

One encoding of the predecode tags for an embodiment of microprocessor 10 employing a variable byte length instruction set will next be described. A variable byte length instruction set is an instruction set in which different instructions may occupy differing numbers of bytes. An exemplary variable byte length instruction set employed by one embodiment of microprocessor 10 is the x86 instruction set.

In the exemplary encoding, if a given byte is the first byte of an instruction, the start bit for that byte is set. If the byte is the last byte of an instruction, the end bit for that byte is set. Instructions which may be directly decoded by decode units 20 are referred to as “fast path” instructions. The remaining x86 instructions are referred to as MROM instructions, according to one embodiment. For fast path instructions, the functional bit is set for each prefix byte included in the instruction, and cleared for other bytes. Alternatively, for MROM instructions, the functional bit is cleared for each prefix byte and set for other bytes. The type of instruction may be determined by examining the functional bit corresponding to the end byte. If that functional bit is clear, the instruction is a fast path instruction. Conversely, if that functional bit is set, the instruction is an MROM instruction. The opcode of an instruction may thereby be located within an instruction which may be directly decoded by decode units 20 as the byte associated with the first clear functional bit in the instruction. For example, a fast path instruction including two prefix bytes, a Mod R/M byte, and an immediate byte would have start, end, and functional bits as follows:

| | |
|---|---|
| Start bits | 10000 |
| End bits | 00001 |
| Functional bits | 11000 |

According to one particular embodiment, early identification of an instruction that includes a scale-index-base (SIB) byte is advantageous for MROM unit 34. For such an embodiment, if an instruction includes at least two bytes after the opcode byte, the functional bit for the Mod R/M byte indicates the presence of an SIB byte. If the functional bit for the Mod R/M byte is set, then an SIB byte is present. Alternatively, if the functional bit for the Mod R/M byte is clear, then an SIB byte is not present.

MROM instructions are instructions which are determined to be too complex for decode by decode units 20. MROM instructions are executed by invoking MROM unit 34. More specifically, when an MROM instruction is encountered, MROM unit 34 parses and issues the instruction into a subset of defined fast path instructions to effectuate the desired operation. MROM unit 34 dispatches the subset of fast path instructions to decode units 20. A listing of exemplary x86 instructions categorized as fast path instructions will be provided further below.

Microprocessor 10 employs branch prediction in order to speculatively fetch instructions subsequent to conditional branch instructions. Branch prediction unit 14 is included to perform branch prediction operations. In one embodiment, up to two branch target addresses are stored with respect to each 16 byte portion of each cache line in instruction cache 16. Prefetch/predecode unit 12 determines initial branch targets when a particular line is predecoded. Subsequent updates to the branch targets corresponding to a cache line may occur due to the execution of instructions within the cache line. Instruction cache 16 provides an indication of the instruction address being fetched, so that branch prediction unit 14 may determine which branch target addresses to select for forming a branch prediction. Decode units 20 and functional units 24 provide update information to branch prediction unit 14. Because branch prediction unit 14 stores two targets per 16 byte portion of the cache line, some branch instructions within the line may not be stored in branch prediction unit 14. Decode units 20 detect branch instructions which were not predicted by branch prediction unit 14. Functional units 24 execute the branch instructions and determine if the predicted branch direction is incorrect. The branch direction may be “taken”, in which subsequent instructions are fetched from the target address of the branch instruction. Conversely, the branch direction may be “not taken”, in which subsequent instructions are fetched from memory locations consecutive to the branch instruction. When a mispredicted branch instruction is detected, instructions subsequent to the mispredicted branch are discarded from the various units of microprocessor 10. A variety of suitable branch prediction algorithms may be employed by branch prediction unit 14.

Instructions fetched from instruction cache 16 are conveyed to instruction alignment unit 18. As instructions are fetched from instruction cache 16, the corresponding predecode data is scanned to provide information to instruction alignment unit 18 (and to MROM unit 34) regarding the instructions being fetched. Instruction alignment unit 18 utilizes the scanning data to align an instruction to each of decode units 20. In one embodiment, instruction alignment unit 18 aligns instructions from three sets of eight instruction bytes to decode units 20. Instructions are selected independently from each set of eight instruction bytes into preliminary issue positions. The preliminary issue positions are then merged to a set of aligned issue positions corresponding to decode units 20, such that the aligned issue positions contain the three instructions which are prior to other instructions within the preliminary issue positions in program order. Decode unit 20A receives an instruction which is prior to instructions concurrently received by decode units 20B and 20C (in program order). Similarly, decode unit 20B receives an instruction which is prior to the instruction concurrently received by decode unit 20C in program order.

Decode units 20 are configured to decode instructions received from instruction alignment unit 18. Register operand information is detected and routed to register file 30 and reorder buffer 32. Additionally, if the instructions require one or more memory operations to be performed, decode units 20 dispatch the memory operations to load/store unit 26. Each instruction is decoded into a set of control values for functional units 24, and these control values are dispatched to reservation stations 22 along with operand address information and displacement or immediate data which may be included with the instruction.

Microprocessor 10 supports out of order execution, and thus employs reorder buffer 32 to keep track of the original program sequence for register read and write operations, to implement register renaming, to allow for speculative instruction execution and branch misprediction recovery, and to facilitate precise exceptions. A temporary storage location within reorder buffer 32 is reserved upon decode of an instruction that involves the update of a register to thereby store speculative register states. If a branch prediction is incorrect, the results of speculatively-executed instructions along the mispredicted path can be invalidated in the buffer before they are written to register file 30. Similarly, if a particular instruction causes an exception, instructions subsequent to the particular instruction may be discarded. In this manner, exceptions are “precise” (i.e. instructions subsequent to the particular instruction causing the exception are not completed prior to the exception). It is noted that a particular instruction is speculatively executed if it is executed prior to instructions which precede the particular instruction in program order. Preceding instructions may be a branch instruction or an exception-causing instruction, in which case the speculative results may be discarded by reorder buffer 32.

The instruction control values and immediate or displacement data provided at the outputs of decode units 20 are routed directly to respective reservation stations 22. In one embodiment, each reservation station 22 is capable of holding instruction information (i.e., instruction control values as well as operand values, operand tags and/or immediate data) for up to three pending instructions awaiting issue to the corresponding functional unit. It is noted that for the embodiment of FIG. 1, each reservation station 22 is associated with a dedicated functional unit 24. Accordingly, three dedicated “issue positions” are formed by reservation stations 22 and functional units 24. In other words, issue position 0 is formed by reservation station 22A and functional unit 24A. Instructions aligned and dispatched to reservation station 22A are executed by functional unit 24A. Similarly, issue position 1 is formed by reservation station 22B and functional unit 24B; and issue position 2 is formed by reservation station 22C and functional unit 24C.

Upon decode of a particular instruction, if a required operand is a register location, register address information is routed to reorder buffer 32 and register file 30 simultaneously. Those of skill in the art will appreciate that the x86 register file includes eight 32 bit real registers (i.e., typically referred to as EAX, EBX, ECX, EDX, EBP, ESI, EDI and ESP). In embodiments of microprocessor 110 which employ the x86 microprocessor architecture, register file 32 comprises storage locations for each of the 32 bit real registers. Additional storage locations may be included within register file 32 for use by MROM unit 34. Reorder buffer 30 contains temporary storage locations for results which change the contents of these registers to thereby allow out of order execution. A temporary storage location of reorder buffer 32 is reserved for each instruction which, upon decode, is determined to modify the contents of one of the real registers. Therefore, at various points during execution of a particular program, reorder buffer 32 may have one or more locations which contain the speculatively executed contents of a given register. If following decode of a given instruction it is determined that reorder buffer 32 has a previous location or locations assigned to a register used as an operand in the given instruction, the reorder buffer 32 forwards to the corresponding reservation station either: 1) the value in the most recently assigned location, or 2) a tag for the most recently assigned location if the value has not yet been produced by the functional unit that will eventually execute the previous instruction. If reorder buffer 32 has a location reserved for a given register, the operand value (or reorder buffer tag) is provided from reorder buffer 10 rather than from register file 17. If there is no location reserved for a required register in reorder buffer 10, the value is taken directly from register file 17. If the operand corresponds to a memory location, the operand value is provided to the reservation station through load/store unit 32.

In one particular embodiment, reorder buffer 32 is configured to store and manipulate concurrently decoded instructions as a unit. This configuration will be referred to herein as “line-oriented”. By manipulating several instructions together, the hardware employed within reorder buffer 32 may be simplified. For example, a line-oriented reorder buffer included in the present embodiment allocates storage sufficient for instruction information pertaining to three instructions (one from each decode unit) whenever one or more instructions are dispatched by decode units 20. By contrast, a variable amount of storage is allocated in conventional reorder buffers, dependent upon the number of instructions actually dispatched. A comparatively larger number of logic gates may be required to allocate the variable amount of storage. When each of the concurrently decoded instructions has executed, the instruction results are stored into register file 30 simultaneously. The storage is then free for allocation to another set of concurrently decoded instructions. Additionally, the amount of control logic circuitry employed per instruction is reduced because the control logic is amortized over several concurrently decoded instructions. A reorder buffer tag identifying a particular instruction may be divided into two fields: a line tag and an offset tag. The line tag identifies the set of concurrently decoded instructions including the particular instruction, and the offset tag identifies which instruction within the set corresponds to the particular instruction. It is noted that storing instruction results into register file 30 and freeing the corresponding storage is referred to as “retiring” the instructions. It is further noted that any reorder buffer configuration may be employed in various embodiments of microprocessor 10.

As noted earlier, reservation stations 22 store instructions until the instructions are executed by the corresponding functional unit 24. An instruction is selected for execution if: (i) the operands of the instruction have been provided; and (ii) the operands have not yet been provided for instructions which are within the same reservation station 22A-22C and which are prior to the instruction in program order. It is noted that when an instruction is executed by one of the functional units 24, the result of that instruction is passed directly to any reservation stations 22 that are waiting for that result at the same time the result is passed to update reorder buffer 32 (this technique is commonly referred to as “result forwarding”). An instruction may be selected for execution and passed to a functional unit 24A-24C during the clock cycle that the associated result is forwarded. Reservation stations 22 route the forwarded result to the functional unit 24 in this case.

In one embodiment, each of the functional units 24 is configured to perform integer arithmetic operations of addition and subtraction, as well as shifts, rotates, logical operations, and branch operations. The operations are performed in response to the control values decoded for a particular instruction by decode units 20. It is noted that a floating point unit (not shown) may also be employed to accommodate floating point operations. The floating point unit may be operated as a coprocessor, receiving instructions from MROM unit 34 and subsequently communicating with reorder buffer 32 to complete the instructions. Additionally, functional units 24 may be configured to perform address generation for load and store memory operations performed by load/store unit 26.

Each of the functional units 24 also provides information regarding the execution of conditional branch instructions to the branch prediction unit 14. If a branch prediction was incorrect, branch prediction unit 14 flushes instructions subsequent to the mispredicted branch that have entered the instruction processing pipeline, and causes fetch of the required instructions from instruction cache 16 or main memory. It is noted that in such situations, results of instructions in the original program sequence which occur after the mispredicted branch instruction are discarded, including those which were speculatively executed and temporarily stored in load/store unit 26 and reorder buffer 32.

Results produced by functional units 24 are sent to reorder buffer 32 if a register value is being updated, and to load/store unit 26 if the contents of a memory location are changed. If the result is to be stored in a register, reorder buffer stores the result in the location reserved for the value of the register when the instruction was decoded. A plurality of result buses 38 are included for forwarding of results from functional units 24 and load/store unit 26. Result buses 38 convey the result generated, as well as the reorder buffer tag identifying the instruction being executed.

Load/store unit 26 provides an interface between functional units 24 and data cache 28. In one embodiment, load/store unit 26 is configured with a load/store buffer having eight storage locations for data and address information for pending loads or stores. Decode units 20 arbitrate for access to the load/store unit 26. When the buffer is full, a decode unit must wait until load/store unit 26 has room for the pending load or store request information. Load/store unit 32 also performs dependency checking for load memory operations against pending store memory operations to ensure that data coherency is maintained. A memory operation is a transfer of data between microprocessor 10 and the main memory subsystem. Memory operations may be the result of an instruction which utilizes an operand stored in memory, or may be the result of a load/store instruction which causes the data transfer but no other operation. Additionally, load/store unit 26 may include a special register storage for special registers such as the segment registers and other registers related to the address translation mechanism defined by the x86 microprocessor architecture.

In one embodiment, load/store unit 26 is configured to perform load memory operations speculatively. Store memory operations are performed in program order, but may be speculatively stored into the predicted way. If the predicted way is incorrect, the data prior to the store memory operation is subsequently restored to the predicted way and the store memory operation is performed to the correct way. In another embodiment, stores may be executed speculatively as well. Speculatively executed stores are placed into a store buffer, along with a copy of the cache line prior to the update. If the speculatively executed store is later discarded due to branch misprediction or exception, the cache line may be restored to the value stored in the buffer. It is noted that load/store unit 26 may be configured to perform any amount of speculative execution, including no speculative execution.

Data cache 28 is a high speed cache memory provided to temporarily store data being transferred between load/store unit 26 and the main memory subsystem. In one embodiment, data cache 28 has a capacity of storing up to sixteen kilobytes of data in an eight way set associative structure. Similar to instruction cache 16, data cache 28 may employ a way prediction mechanism. It is understood that data cache 28 may be implemented in a variety of specific memory configurations, including a set associative configuration.

In one particular embodiment of microprocessor 10 employing the x86 microprocessor architecture, instruction cache 16 and data cache 28 are linearly addressed. The linear address is formed from the offset specified by the instruction and the base address specified by the segment portion of the x86 address translation mechanism. Linear addresses may optionally be translated to physical addresses for accessing a main memory. The linear to physical translation is specified by the paging portion of the x86 address translation mechanism. It is noted that a linear addressed cache stores linear address tags. A set of physical tags (not shown) may be employed for mapping the linear addresses to physical addresses and for detecting translation aliases. Additionally, the physical tag block may perform linear to physical address translation.

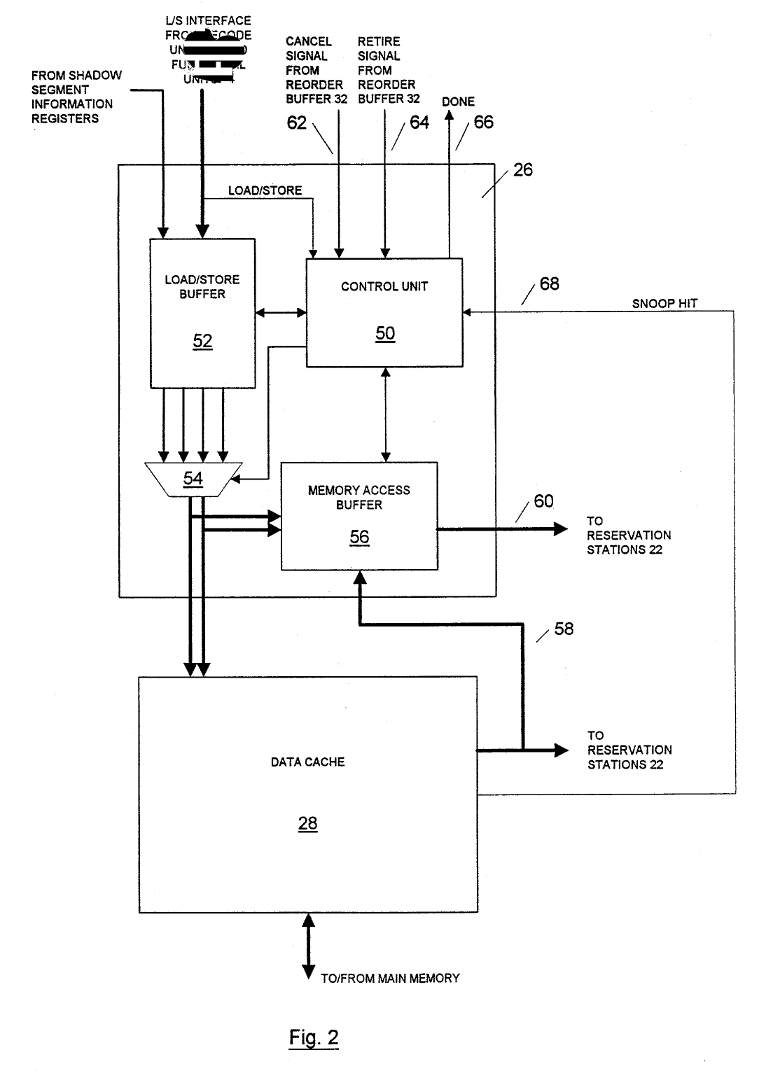

Turning now to FIG. 2, a block diagram of one embodiment of load/store unit 26 is shown. As shown in FIG. 2, load/store unit 26 comprises control unit 50, load/store buffer 52, multiplexer 54 and memory access buffer 56. Control unit 50 is coupled to load/store buffer 52, multiplexer 54, and memory access buffer 56. Other embodiments are possible and contemplated. Control unit 52 provides the control logic for load/store unit 26 and receives control signals from other parts of the microprocessor 10. Specifically for this embodiment, control unit 50 receives cancel signal 62 from reorder buffer 32 when a branch misprediction or exception occurs. Upon receiving such a cancel signal 62, control unit 50 directs load/store buffer 52 to purge any stored information associated with instructions after the mispredicted branch instruction (in program order). Control unit 50 also receives retire signal 64 from reorder buffer 32. Upon receiving a retire signal, control unit 50 directs load/store buffer 52 to perform the memory operation corresponding to the retired instruction. Control unit 50 indicates completion of the memory operation corresponding to the retired instruction to reorder buffer 32 by transmitting done signal 66. Control unit 50 receives an indication of whether each memory operation is a load or store from decode units 20. Control unit 50 also receives an indication that a snoop hit has occurred in data cache 28 via snoop hit line 68.

Load/store buffer 52 is configured to store instruction information for load and store memory operations. Control unit 50 controls where new information is stored in load/store buffer 52 (i.e., allocation of buffer entries to load/store memory operations signaled by decode units 20) and the sequence in which memory operations are sent from load/store buffer 52 to data cache 28.

Multiplexer 54 selects, under the direction of control unit 50, which entry within load/store buffer 52 is to be sent to data cache 28. In one embodiment, data cache 28 is configured as a dual-ported cache, and multiplexer 54 is accordingly configured to select up to two memory operations in a given clock cycle. Multiplexer 54 may be configured to select from a particular subset of all entries in load/store buffer 52, e.g., the subset may comprise a predetermined number of the oldest entries in load/store buffer 52.

Memory access buffer 56 is coupled to multiplexer 54 and is configured to store requested addresses and associated data for the most recent memory operations. Most recent memory operations is defined to mean the last N memory operations performed to different addresses, where N is a predetermined number indicating the number of storage locations within memory access buffer 56. Memory access buffer 56 monitors the output of multiplexer 54 for memory operations. Upon determining that a memory operation is being conveyed to data cache 28, memory access buffer 56 performs one of the following tasks.

Load Memory Accesses

If the memory operation is a load, memory access buffer 56 compares the selected request address from multiplexer 54 with the addresses currently stored within memory access buffer 56. If a stored address matches the requested address, memory access buffer 56 outputs the data associated with the matching address to reservation stations 22 and/or reorder buffer 32 via second result bus 60. As memory access buffer 56 is smaller than data cache 28, it may be accessed more rapidly than data cache 28. Advantageously, the requested data may be provided to reservation stations 22 in a shorter period of time, e.g., one less clock cycle. Furthermore, control unit 50 may be configured to send a cancel signal to data cache 28 once an address match is found. This advantageously allows data cache 28 to abort the unnecessary memory access.

Alternatively, if the requested load address is not stored within memory access buffer 56, memory access buffer allocates a storage location and stores the requested address within the storage location. When the data associated with the requested address is output by data cache 28 onto result bus 58, memory access buffer 56 reads the data and stores it with the requested address.

Store Memory Accesses

Upon detecting a store memory operation to data cache 28, memory access buffer 56 is configured to store the requested address and the associated data. Allocating a location within memory access buffer 56 for the requested address and data may be performed in several ways. In one embodiment, memory access buffer searches its contents for a matching address. If a match is found, the new store data simply overwrites the old store data while the address remains the same. In another embodiment, the matching address's storage location may be invalidated. The new store address and data then overwrite the oldest entry in the buffer. The invalidated entry may eventually be overwritten with a new address and data as other memory accesses are performed.

While memory access buffer 56 stores addresses and data for store memory operations as described above, the store memory operations also update the data cache and/or memory in the usual manner. Therefore, the data stored in memory access buffer 56 is represented elsewhere.

Data Cache Snoops

In one embodiment, memory access buffer 56 is configured to invalidate all storage locations upon detecting a data cache snoop hit. This feature advantageously aids in maintaining data coherency between memory access buffer 56 and data cache 28 without requiring large amounts of die space or complicated circuitry.

An additional feature that may be implemented within load/store unit 26 is snoop forwarding. This may prevent memory access buffer 56 from storing old data. For example, when a store is executed, memory access buffer 56 stores of a copy of the data. If, on a subsequent load, data cache 28 overwrites the line containing that data with other data corresponding to another address (i.e., reusing the cache line), memory access buffer 56 will then have a copy of data that is not in data cache 28. A second processor could then access that data in memory and change it without causing a snoop hit in the data cache. This could result in memory access buffer 56 storing an outdated copy of the data. Snoop forwarding remedies this potential problem by routing snoops to memory access buffer 56 and data cache 28. This ensures that a snoop hit will occur if the data being snooped is in data cache 28 or memory access buffer 56.

An alternative method to prevent memory access buffer 56 from storing old data is to clear memory access buffer 56 when a corresponding cache line is reused. In one embodiment, this may be accomplished is by storing a status bit in data cache 28 for each cache line. The status bit indicates whether or not the corresponding data is stored in memory access buffer 56. When a cache line having data stored in memory access buffer 56 is reused, data cache 28 signals memory access buffer 56 so that the data may be cleared.

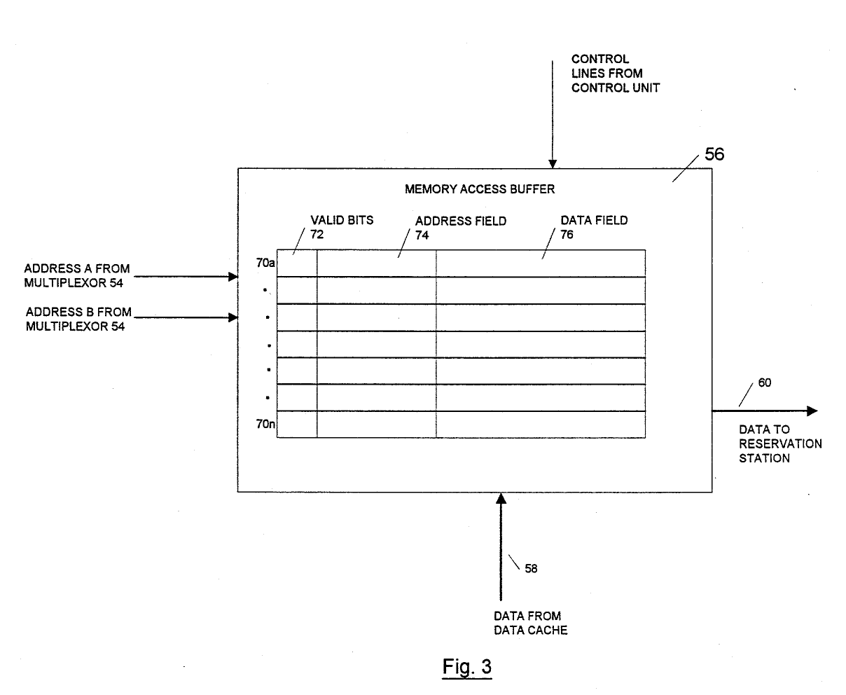

Turning now to FIG. 3, a diagram illustrating one embodiment of memory access buffer 56 is shown. In this embodiment, memory access buffer 56 is configured as a content addressable memory (“CAM”) first-in first-out buffer (“FIFO”). In this configuration, each storage location 70a-70n comprises three portions: an address field 74, a data field 76, and a valid bit 72. In one embodiment, the data field stores 32 bits of information. Other sizes are also possible, e.g., part of a cache line, or an entire cache line.

In one embodiment, memory access buffer 56 is capable of storing 32 entries 70a-70n (again, other sizes may be used). The FIFO may be implemented as a circular buffer in which a pointer is used to indicate the next storage location to be written to. Memory access buffer 56 may also be configured as a dual-ported buffer, thereby allowing two requested addresses to be compared in a given clock cycle. Each storage location 70a-70n is then searched using the memory operation's requested address as the lookup value. If a match occurs between the requested address and one of the addresses stored within buffer 56, the corresponding data is provided.

As previously noted, upon a snoop hit in data cache 28, the contents of memory access buffer 56 are invalidated. This may be accomplished by clearing valid bits 72. Valid bits 72 may also be used to invalidate an entry that contains a requested address and associated data that has been superseded by a more recent entry in memory access buffer 56 (see discussion above regarding Store Memory Accesses). Furthermore, valid bits 72 may be cleared upon start-up of microprocessor 10 to indicate that memory access buffer 56 is empty.

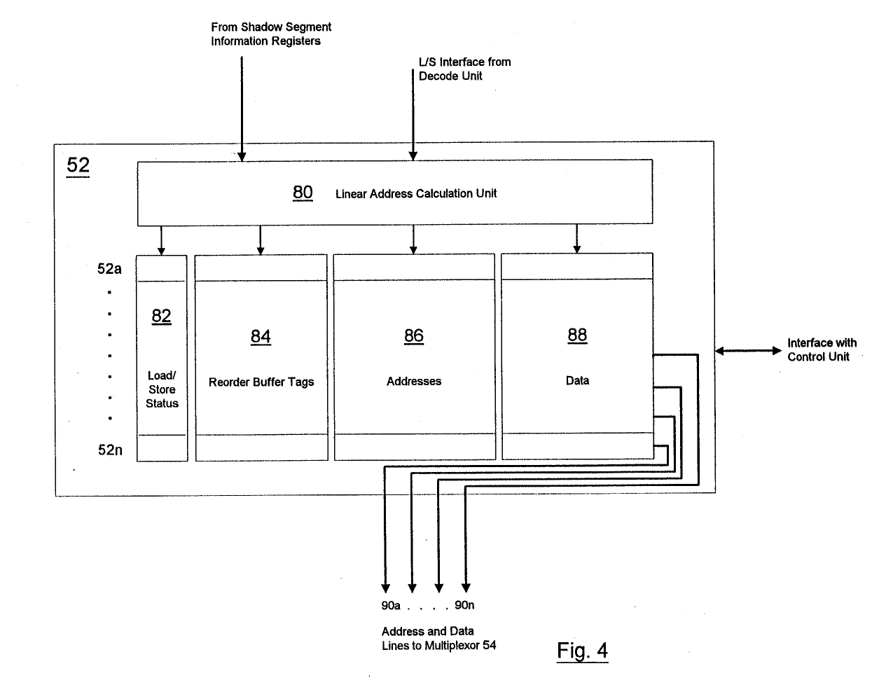

FIG. 4 is a diagram showing one embodiment of load/store buffer 52. In this embodiment, load store buffer 52 comprises a linear address calculation unit 80 and a series of storage locations 52a-52n. One of storage locations 52a-52n is allocated for each memory operation sent to load/store buffer 52 from decode units 20.

Linear address calculation unit 80 receives information concerning memory operations from decode units 20 and address generation units (e.g., functional units 24 or separate dedicated address generation units). This information includes a reorder buffer tag for the memory operation, a logical address, an indication as to whether the memory operation is a load or a store, and data (or a tag if the data is unavailable) for a store operation. This information also includes an indication as to which segment register, if any, is to be used in calculating the linear address. Linear address calculation unit 80 uses this information to read the appropriate segment base address from shadow segment information registers (not shown). Shadow segment information registers contain copies of the current values of segment registers and are not accessible to the programmer. Linear address calculation unit 80 adds the segment base address to the logical address to determine the linear address. The linear address is stored in one of storage locations 52a-52n along with other information provided by decode units 20. Note that linear address calculation need not be performed within load/store buffer 52; it may be performed by functional units 24 or by other circuitry within microprocessor 10. If the segment base is equal to zero, than linear address calculation may be bypassed because the logical and linear addresses are equal. Bypassing linear address calculation will save time, typically one clock cycle.

Each storage location 52a-52n comprises a load/store status field 82, a load/store tag field 84, an address field 86, and a data field 88. Load/store status field 86 stores information indicating whether the particular memory operation associated with that particular storage location is a load or a store operation. The load/store tag field stores a tag for each memory access. The tags are provided by decode units 20 and are used by reorder buffer 32 and reservation stations 22 to keep track of which memory operations stored in load/store buffer 52 are part of a particular instruction. The tags are also used for forwarding results to dependent instructions within reservation stations 22. Address field 86 stores the translated linear address which is provided from linear address calculation unit 80. Finally, data field 88 stores data associated with store memory operations. In addition to the fields listed above, valid bits similar to valid bits 58 may be used to store valid/invalid information for each particular storage location 52a-52n to aid control unit 50 in allocating storage locations for incoming memory operations.

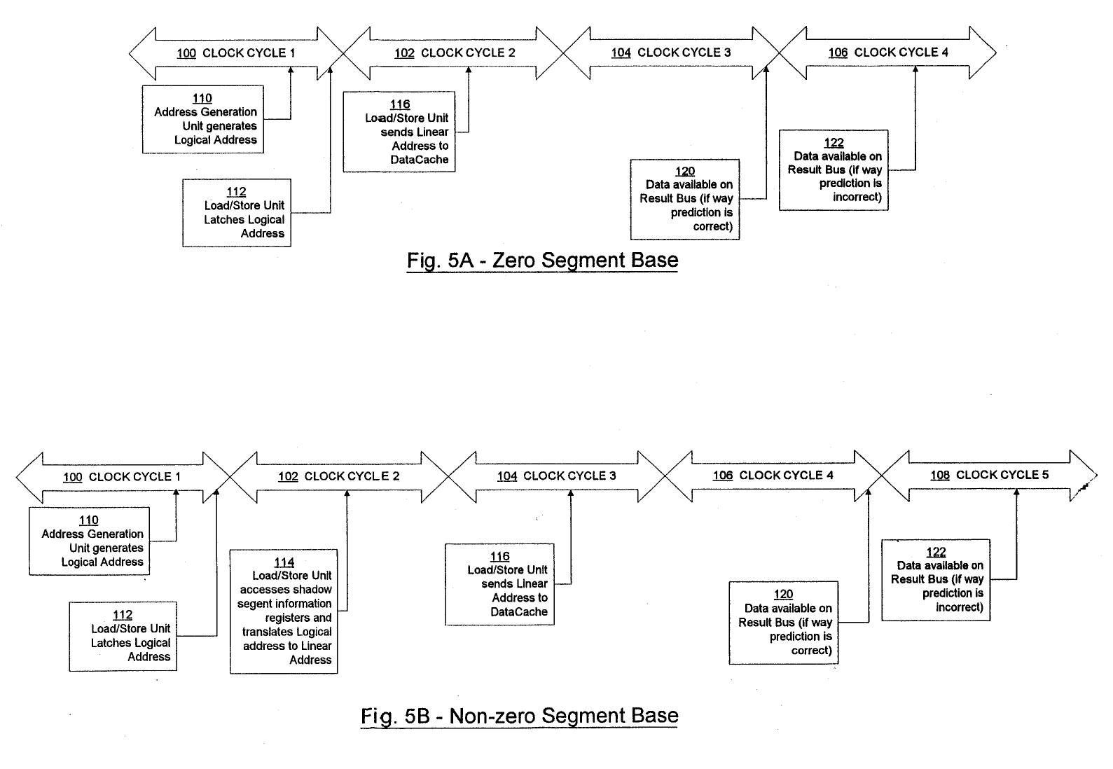

Turning now to FIGS. 5A-7B, timing diagrams depicting the relationship between load/store unit 52 and data cache 28 are shown. FIGS. 5A, 6A and 7A show the relative timing of events for a memory access having a zero segment base. As those skilled in the art will appreciate, a zero segment base indicates that the linear address is equal to the logical address. Thus no linear address calculation is needed.

Referring now to FIG. 5A, the relative timing of a load/store unit (without memory access buffer 56) and a data cache is shown for a memory access with a zero segment base. In the first clock cycle 100, the logical address is generated (block 110). The load/store unit latches the logical address (block 112) near the end of the first clock cycle 100. During the second clock cycle 102, the load/store unit sends the latched linear address to data cache 28 (block 116). During the third clock cycle 104, the data cache performs way prediction and outputs the requested data on result bus 58 (block 120). If the way prediction is determined to be incorrect, the data cache outputs the requested data (block 122) during the fourth clock cycle 106.

Similarly, FIG. 5B shows the relative timing of a load/store unit (without memory access buffer 56) and a data cache for a memory access with a non-zero segment base. As illustrated in FIG. b, a non-zero segment base address requires an extra cycle to translate. During the second clock cycle 102, the load/store unit accesses shadow segment information registers and translates the logical address into a linear address (block 114). During the third clock cycle 104, the load/store unit sends the calculated linear address to data cache 28 (block 116). The remaining steps follow in the same order as described above and as pictured in FIG. 5A, albeit one clock cycle later.

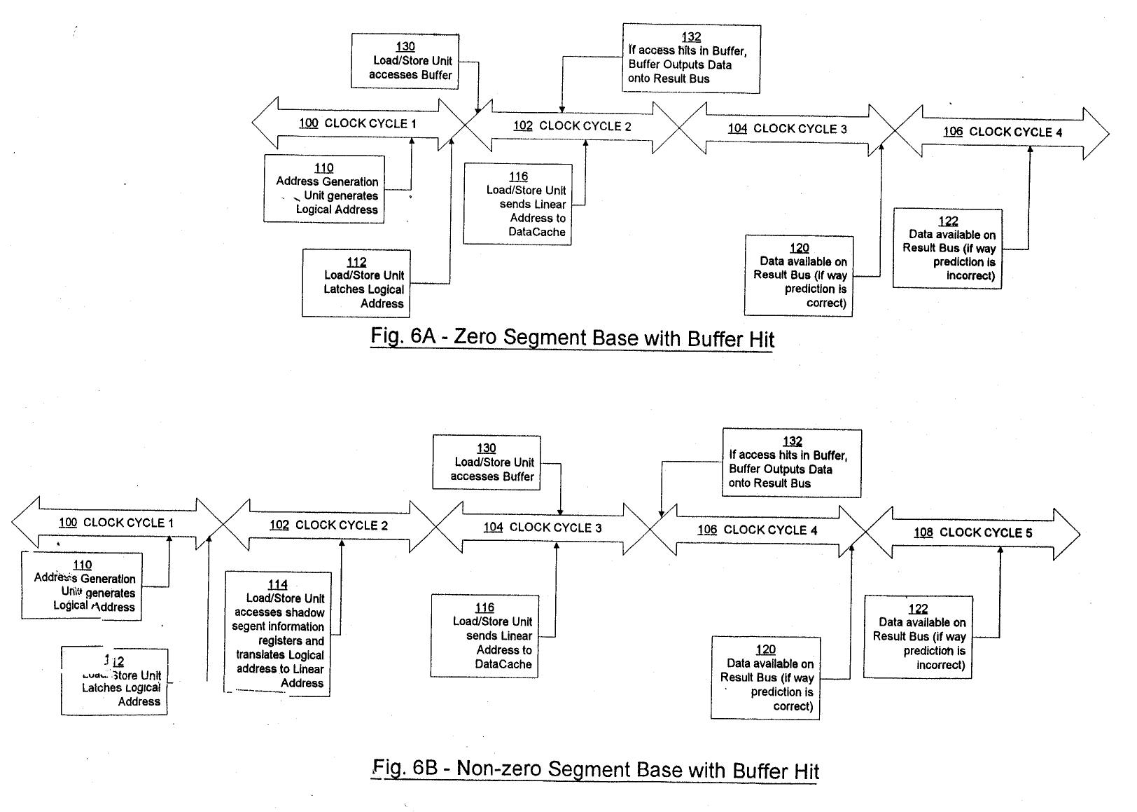

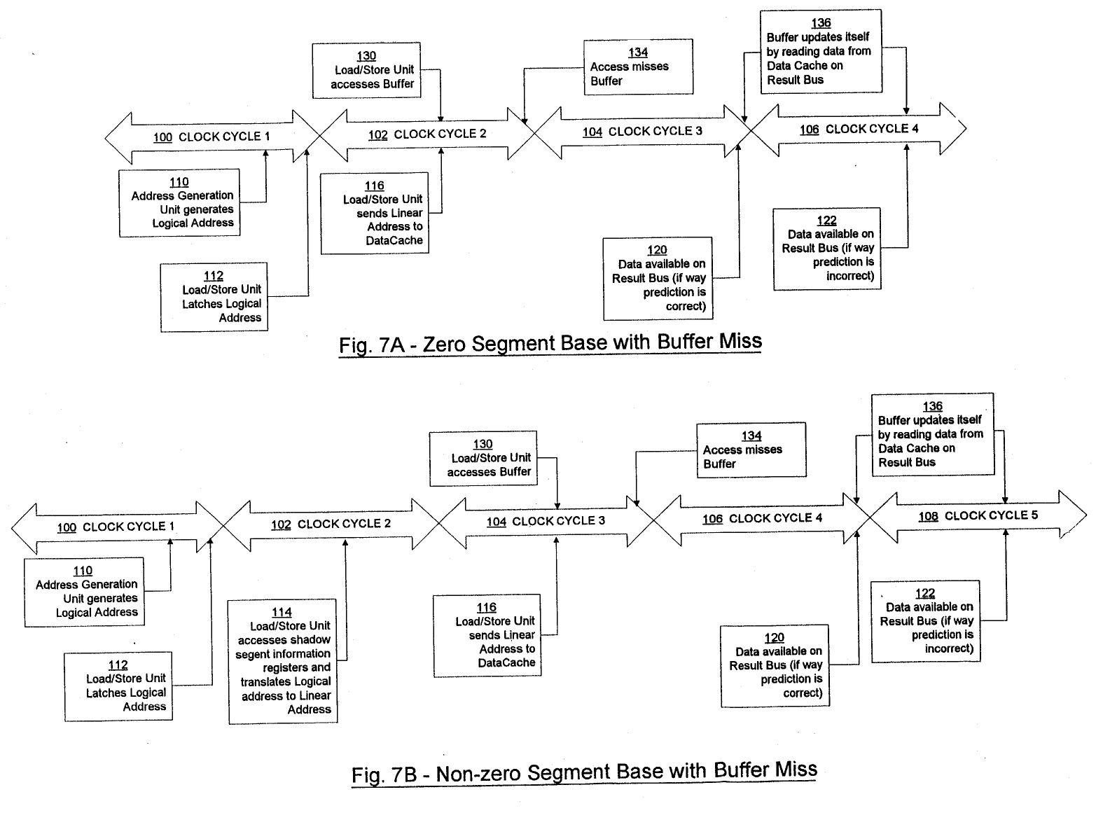

Turning now to FIGS. 6A-7B, timing diagrams depicting the relationship between one embodiment of load/store unit 26 (with memory access buffer 56) and data cache 28 are shown. FIG. 6A depicts the relative timing when a memory operation's requested address is found in memory access buffer 56, i.e., a “hit” in memory access buffer 56, for a zero segment base memory access. During the second clock cycle 102, load/store unit accesses memory access buffer 56 (block 130). If the access hits in memory access buffer 56, buffer 56 outputs the data onto result bus 60 (block 132) near the end of the second clock cycle 102. Advantageously, the requested data may be provided an entire clock cycle earlier when compared with the load/store unit illustrated in FIG. 5A.

Similarly, FIG. 6B depicts the relative timing when a memory operand's requested address is found in memory access buffer 56 for a non-zero segment base memory access. During the second clock cycle 102, the load/store unit accesses shadow segment information registers and translates the logical address into a linear address (block 114). During the third clock cycle 104, the load/store unit sends the calculated linear address to data cache 28 (block 116 and accesses memory access buffer 56 (block 130). If the access hits in memory access buffer 56, buffer 56 outputs the data onto result bus 60 (block 132) near the end of the third clock cycle 104. Once again, the data may advantageously be provided a clock cycle earlier when compared the load/store unit illustrated in FIG. 5A.

Turning now to FIG. 7A, a timing diagram depicting the relationship between load/store unit 26 and data cache 28 is depicted when a buffer “miss” occurs for a zero segment base memory access, i.e., the requested address is not found within memory access buffer 56. At the end of the second clock cycle 102, load/store unit 26 determines that the requested memory address misses the memory access buffer 56 (block 134). Load/store unit 26 waits until the requested data cache is available upon result bus 58, i.e., near the end of the third clock cycle 104. Memory access buffer 56 then updates its contents by storing the data output by the data cache on result bus 58 (block 136) near the end of the third clock cycle 104 (for a correct way prediction) or the fourth clock cycle 105 (for an incorrect way prediction).

Similarly, FIG. 7B depicts the relationship between load/store unit 26 and data cache 28 when a buffer miss occurs for a non-zero segment base memory access. The timing is similar to that depicted in FIG. 7A, except that linear address calculation uses an extra clock cycle, thereby delaying all other operations one clock cycle. Advantageously, in both cases (zero segment base and non-zero segment base) there is no clock cycle penalty over the load/store unit depicted in FIG. 5A and FIG. 5B.

While FIGS. 5A-7B illustrate the use of way prediction, load/store unit 26 may be used in conjunction with a data cache 28 that does not support way prediction. Way prediction is implemented by using a portion of the requested address to index a direct mapped series of store locations within a set associative cache. Each location in the series stores a way prediction. These way predictions may be generated by storing the way of the last memory access to have the same address portion. While the predicted way is being looked up, a particular row in the data cache array is also being indexed by a second portion of the address. In some configurations, the first and second portions may be the same or overlap. Once the row is selected, the way prediction is used to select a particular way within the accessed row. The selected way is later verified through tag comparison. If the way prediction is correct, the data is available sooner than it would be available if the normal tag comparison would have to be done.

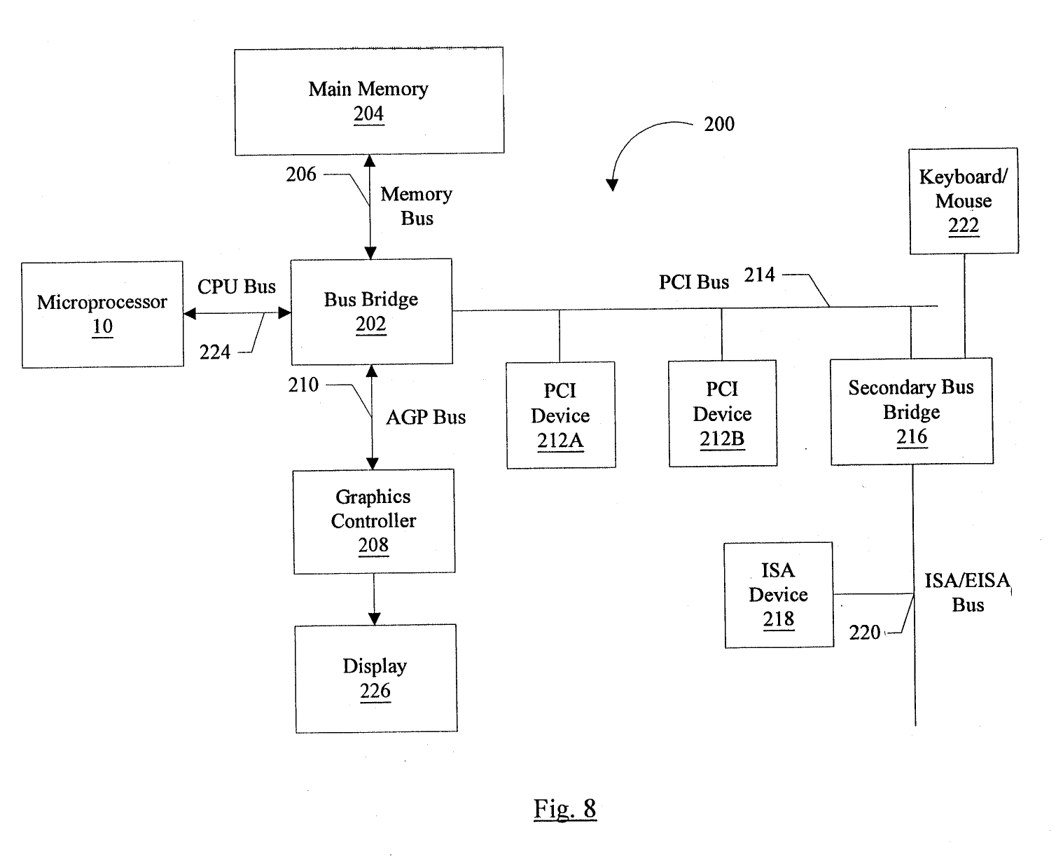

Turning now to FIG. 8, a block diagram of a computer system 200 including microprocessor 10 coupled to a variety of system components through a bus bridge 202 is shown. In the depicted system, a main memory 204 is coupled to bus bridge 202 through a memory bus 206, and a graphics controller 208 is coupled to bus bridge 202 through an AGP bus 210. Finally, a plurality of PCI devices 212A-212B are coupled to bus bridge 202 through a PCI bus 214. A secondary bus bridge 216 may further be provided to accommodate an electrical interface to one or more EISA or ISA devices 218 through an EISA/ISA bus 220. Microprocessor 10 is coupled to bus bridge 202 through a CPU bus 224.

In addition to providing an interface to an ISA/EISA bus, secondary bus bridge 216 may further incorporate additional functionality, as desired. For example, in one embodiment, secondary bus bridge 216 includes a master PCI arbiter (not shown) for arbitrating ownership of PCI bus 214. An input/output controller (not shown), either external from or integrated with secondary bus bridge 216, may also be included within computer system 200 to provide operational support for a keyboard and mouse 222 and for various serial and parallel ports, as desired. An external cache unit (not shown) may further be coupled to CPU bus 224 between microprocessor 10 and bus bridge 202 in other embodiments. Alternatively, the external cache may be coupled to bus bridge 202 and cache control logic for the external cache may be integrated.

Main memory 204 is a memory in which application programs are stored and from which microprocessor 10 primarily executes. A suitable main memory 204 comprises DRAM (Dynamic Random Access Memory), and preferably a plurality of banks of SDRAM (Synchronous DRAM).

PCI devices 212A-212B are illustrative of a variety of peripheral devices such as, for example, network interface cards, video accelerators, audio cards, hard or floppy disk drives or drive controllers, SCSI (Small Computer Systems Interface) adapters and telephony cards. Similarly, ISA device 218 is illustrative of various types of peripheral devices, such as a modem.

Graphics controller 208 is provided to control the rendering of text and images on a display 226. Graphics controller 208 may embody a typical graphics accelerator generally known in the art to render three-dimensional data structures which can be effectively shifted into and from main memory 204. Graphics controller 208 may therefore be a master of AGP bus 210 in that it can request and receive access to a target interface within bridge logic unit 102 to thereby obtain access to main memory 204. A dedicated graphics bus accommodates rapid retrieval of data from main memory 204. For certain operations, graphics controller 208 may further be configured to generate PCI protocol transactions on AGP bus 210. The AGP interface of bus bridge 302 may thus include functionality to support both AGP protocol transactions as well as PCI protocol target and initiator transactions. Display 226 is any electronic display upon which an image or text can be presented. A suitable display 226 includes a cathode ray tube (“CRT”), a liquid crystal display (“LCD”), etc. It is noted that, while the AGP, PCI, and ISA or EISA buses have been used as examples in the above description, any bus architectures may be substituted as desired.

It is still further noted that the present discussion may refer to the assertion of various signals. As used herein, a signal is “asserted” if it conveys a value indicative of a particular condition. Conversely, a signal is “deasserted” if it conveys a value indicative of a lack of a particular condition. A signal may be defined to be asserted when it conveys a logical zero value or, conversely, when it conveys a logical one value. Additionally, various values have been described as being discarded in the above discussion. A value may be discarded in a number of manners, but generally involves modifying the value such that it is ignored by logic circuitry which receives the value. For example, if the value comprises a bit, the logic state of the value may be inverted to discard the value. If the value is an n-bit value, one of the n-bit encodings may indicate that the value is invalid. Setting the value to the invalid encoding causes the value to be discarded. Additionally, an n-bit value may include a valid bit indicative, when set, that the n-bit value is valid. Resetting the valid bit may comprise discarding the value. Other methods of discarding a value may be used as well.

Numerous variations and modifications will become apparent to those skilled in the art once the above disclosure is fully appreciated. It is intended that the following claims be interpreted to embrace all such variations and modifications.

What is claimed is:

1. A load/store unit comprising:
a load/store buffer coupled to a data cache, wherein said load/store buffer is configured to store information corresponding to a plurality of memory operations, wherein said information comprises a requested address; and
a memory access buffer coupled to said load/store buffer, wherein said memory access buffer is configured to store addresses and data associated with said addresses for at least one previously performed memory operation,
wherein said memory access buffer is configured, upon detecting a load memory operation conveyed from said load/store buffer to said data cache, to output data associated with said load memory operation's requested address to a result bus if said load memory operation's requested address matches one of said addresses stored within said memory access buffer, wherein said memory access buffer is configured to store said load memory operation's requested address and associated data provided from said data cache if said load memory operation's requested address is not stored within said memory access buffer.

2. The load/store unit as recited in claim 1, wherein said memory access buffer is configured, upon detecting a store memory operation, to store said store memory operation's requested address and associated data.

3. The load/store unit as recited in claim 2, wherein said load/store unit is further configured to output data associated with said load memory operation's requested address to said result bus at a first time prior to a second time when said data cache outputs said data.

4. The load/store unit as recited in claim 3, wherein said memory access buffer is further configured to overwrite an oldest request address and associated data stored in said memory access buffer if said memory access buffer is full and said load memory operation misses said memory access buffer.

5. The load/store unit as recited in claim 4, wherein said memory access buffer is configured as a CAM FIFO.

6. The load/store unit as recited in claim 4, wherein said memory access buffer is configured to store said load memory operation's requested address and associated data from said data cache when said load memory operation's requested address is not stored within said memory access buffer.

7. The load/store unit as recited claim 6, wherein said load/store unit is further configured to convey requested addresses to said data cache, and wherein said memory access buffer is configured to monitor said requested addresses.

8. The load/store unit as recited in claim 7, wherein said load/store unit is configured to invalidate the contents of said memory access buffer upon detecting a snoop hit to said data cache.

9. The load/store unit recited in claim 8, further comprising a control unit coupled to said load/store buffer and said memory access buffer.

10. The load/store unit as recited in claim 9, further comprising a multiplexer coupled to said load/store buffer, said memory access buffer, said data cache, and said control unit, wherein said multiplexer is configured to select a particular request address from said information stored within said load/store buffer for access to said data cache, wherein said multiplexer is configured to perform said selection under the direction of said control unit.

11. A load/store unit comprising:
a load/store buffer configured to store information for a plurality of memory operations, wherein said information comprises a requested address, a tag, and status information corresponding to each of said plurality of memory operations;
a multiplexer coupled to said load/store buffer, wherein said multiplexer is configured to select at least one address from said load/store buffer for access to a data cache; and
a memory access buffer coupled to said multiplexer, wherein said memory access buffer is configured to store requested address and associated data information for at least one previously performed memory operation, wherein said memory access buffer is configured receive said at least one address from said multiplexer and to output corresponding stored data associated with said at least one address.

12. The load/store unit as recited in claim 11 wherein said memory access buffer is further configured to store requested address and data information from a data cache upon a memory access buffer miss.

13. The load/store unit as recited in claim 12 wherein said memory access buffer is a CAM FIFO.

14. The load/store unit as recited in claim 13 wherein said memory access buffer is configured to output said corresponding stored data prior to said data cache outputting said corresponding stored data.

15. The load/store unit as recited in claim 14, wherein said load/store unit is configured to invalidate the contents of said memory access buffer upon detecting a snoop hit to said data cache.

16. A method for providing fast access to memory data comprising:
storing data and requested address information from store memory operations in a memory access buffer,
outputting data stored in said memory access buffer that is associated with a particular request address onto a result bus upon detecting a load memory operation that requests said particular request address if said particular request address is stored within said memory access buffer,
storing data and requested address information in said memory access buffer for load memory operations that request addresses that are not already stored within said memory access buffer.

17. The method as recited in claim 16, wherein a data cache is coupled to receive said particular request address, and wherein said outputting occurs prior to a data cache outputting data.

18. The method as recited in claim 17, wherein said storing comprises overwriting an oldest requested address and associated data stored in said memory access buffer if said memory access buffer is full.
